(19) United States
(12) Patent Application Publication
(10) Pub. No.: US 2021/0289981 A1
(43) Pub. Date: Sep. 23, 2021

(54) APPARATUS FOR PREPARING A BEVERAGE

(71) Applicant: Conopco, Inc., d/b/a UNILEVER, Englewood Cliffs, NJ (US)

(72) Inventors: Roberto DE MARTIS, Heerbrugg (CH); Richard Heinz PODUSEL, Heerbrugg (CH)

(21) Appl. No.: 16/321,679

(22) PCT Filed: Jul. 20, 2017
(86) PCT No.: PCT/EP2017/068330

§ 371 Date: Jan. 29, 2019

(30) Foreign Application Priority Data
Aug. 11, 2016 (EP) 16183745.5

(51) Int. Cl. A47J 31/40; A47J 31/54; A47J 31/60

(52) U.S. Cl. CPC A47J 31/407; A47J 31/60; A47J 31/401; A47J 31/542

(57) ABSTRACT

An apparatus for preparing a beverage from a capsule containing particulate beverage precursor material includes a capsule reception location, a beverage infusion chamber, a puncturing device, a channel, an infusion liquid supply, an infusion liquid flow path, and a device. The capsule reception location is configured to receive the capsule. The beverage infusion chamber has a chamber inlet and a chamber outlet. The puncturing device is configured to puncture the capsule to create a capsule inlet and a capsule outlet. The channel connects the capsule reception location to the beverage infusion chamber. The infusion liquid flow path connects the infusion liquid supply to the chamber inlet of the beverage infusion chamber. The device directs a flowing gas stream into the capsule through the capsule inlet and out of the capsule outlet.

### TECHNICAL FIELD

The invention relates to an apparatus for preparing a beverage from a capsule comprising particulate beverage precursor material.

### BACKGROUND AND PRIOR ART

Many different designs of device for preparing and dispensing a prepared beverage have been suggested. Some of these operate with the use of single-serve capsules, containing sufficient material to prepare a single beverage serving.

In the majority of cases these capsules contain particulate beverage precursor infusion material which can produce a beverage when brought into contact with hot water, such as coffee, cocoa, tea.

In a common arrangement of apparatus, heated water is injected into the capsule so that infusion occurs within the capsule and a prepared beverage exits the capsule for dispensing to the user.

In another type of apparatus, contained particulate material leaves the capsule before preparing the beverage in a separate brewing chamber.

WO2015/135826 discloses an apparatus for dispensing a powder from a capsule using a flow of air.

WO2013/093673 discloses an apparatus for mixing a powder into a liquid by applying an oscillating air flow to a cavity containing the powder.

WO2013/139864 discloses an apparatus for dispensing beverages wherein liquid concentrates are dispensed by use of air and solid material can be dispensed by introducing water.

US2015/079240 discloses an apparatus for dispensing beverages from a capsule, wherein water is injected into the capsule to eject its contents thereby mixing and preparing the beverage prior to dispensing.

One problem with such machines is that such capsules are difficult to handle and dispose of in an efficient and sustainable manner as they typically contain residues of solids and left-over water from the infusion process.

Thus, improvements in this area would be desirable.

### SUMMARY OF INVENTION

In a first aspect, the invention relates to an apparatus for preparing a beverage from a capsule, the capsule comprising particulate beverage precursor material, the apparatus comprising: (1) a capsule reception location; (2) a beverage infusion chamber having a chamber inlet and a chamber outlet; (3) a puncturing device for puncturing the capsule to create a capsule inlet into the capsule and a capsule outlet out of the capsule; (4) a channel connecting the capsule reception location to the beverage infusion chamber; (5) an infusion liquid flow path connecting an infusion liquid supply to a chamber inlet of the infusion chamber; (6) a device for directing a flowing gas stream into the capsule through the capsule inlet and out of the capsule outlet, so that the particulate beverage precursor material is entrained out of the capsule into the flowing gas stream; and the particulate beverage material being subsequently transported along the channel to deliver the particulate beverage precursor material to the infusion chamber.

In a second aspect, the invention relates to a method of preparing a beverage from a capsule employing an apparatus as described herein, the method comprising the steps of: (1) arranging for a capsule to be located at the capsule reception location; (2) puncturing the capsule to create the capsule inlet and capsule outlet; (3) directing a flowing stream of gas into the capsule through the capsule inlet and out of the capsule outlet, so that the particulate beverage precursor material is entrained out of the capsule into the flowing gas stream; and the particulate beverage material being subsequently transported along the channel to deliver the particulate beverage precursor material to the infusion chamber; (4) transporting infusion liquid into the infusion chamber and carrying out an infusion in the infusion chamber; (5) dispensing the prepared beverage from the infusion chamber from a chamber outlet.

Thus, the apparatus is arranged to deliver the contents of the capsule to an infusion chamber by the use of a flowing gas stream. Because the gas flow is not liquid it tends to remove substantially all of the contained particulate material without any sticking to the sides of the capsule. Thus the capsule is substantially free of any contained particulate material and is therefore in a more clean and convenient condition to be handled and recycled by the user.

The apparatus operates by allowing for a flow of infusion liquid, e.g. water, wherein there is a liquid flow path for transporting the infusion liquid from a source, e.g. a reservoir, to an inlet of the beverage infusion chamber. In a preferred embodiment the capsule reception location is remote from the infusion liquid flow path. This means that the capsule does not come into contact with the infusion liquid. This provides the further advantage that the capsule does not interact or come into contact with the infusion liquid, which further assists in keeping disposal of the capsule hygienic and clean.

The apparatus therefore does not fully remove the lid of the capsule, which simplifies the mechanical construction of the apparatus.

Typically the infusion liquid will be water, however other infusion liquids may be envisaged. Preferably the infusion liquid supply comprises a reservoir for supplying infusion liquid.

Preferably the infusion liquid transport channel comprises a heater to heat infusion liquid, e.g. water, as it travels to the infusion chamber.

Preferably the gas employed to entrain the beverage precursor material from the capsule is air, however other gases may be used to similar effect. The device for directing a flowing gas stream into the capsule may take a variety of forms, however preferably the device comprises a fan.

The puncturing device may take a variety of forms, however in one preferred embodiment the puncturing device comprises a rotating arcuate piercer, wherein the piercer forms the inlet of the capsule by entering it from outside the capsule and forms the outlet by exiting the capsule.

It should be mentioned that the inlet and outlet of the capsule could be separate and distinct openings in the capsule. However, it is also possible that the inlet and outlet merge together to produce a single opening, having an inlet region and an outlet region.

Once the inlet and outlet are formed in the capsule, the apparatus allows the introduction of a flowing stream of gas into the inlet.

As discussed above, the capsule is preferably kept away from the infusion liquid in use and therefore there is also preferably provided a separate capsule waste location which remains free of infusion liquid in use. This keeps the capsule waste location hygienic and convenient to store a number of spent capsules before disposal, e.g. by recycling. Preferably the capsule waste location also remains free of spent particulate beverage material.

The apparatus is primarily intended for use in the home of a user and so it is preferable if the machine is automated to produce a beverage quickly and conveniently. Thus, in a preferred embodiment the apparatus comprises a heater to heat the water from the reservoir as it travels to the infusion chamber.

The apparatus is preferably arranged so that it can dispense the formed beverage into a receptacle, such as a cup, once the beverage has been formed in the infusion chamber. Thus the beverage infusion chamber preferably comprises a filtered outlet for dispensing the prepared beverage.

As discussed above, the apparatus is primarily intended for delivery of a single portion of beverage. As such each capsule generally contains sufficient particulate material for form a single portion of beverage. Thus the internal volume of the capsule is preferably from 10 to 24 cm³.

Thus preferably the volume of infusion liquid, e.g. water, delivered to the infusion chamber in a single infusion is from 150 to 300 ml.

The particulate beverage precursor material may be any infusible or soluble material for preparing a beverage such as dried plant material such as tea particles, coffee particles, cocoa, milk powder and the like. Preferably the beverage precursor material comprises dried plant material, preferably tea particles.

The beverage precursor material preferably has a size (i.e. longest diameter) of from 2 to 10 mm, preferably from 3 to 7 mm. In particular, at least 75%, preferably at least 90% by weight of the beverage precursor material have a size of from 2 to 10 mm, preferably from 3 to 7 mm.

The invention will now be illustrated with reference to the following figures, in which:

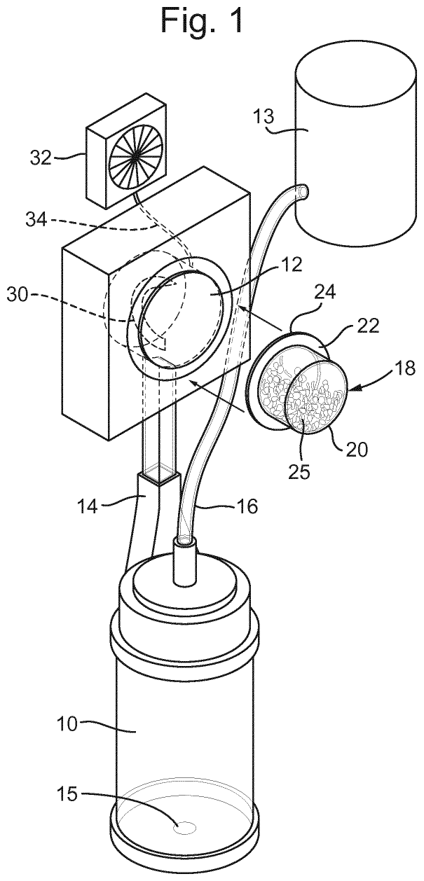

FIG. 1 is a view of an internal group of components for use in a beverage machine.

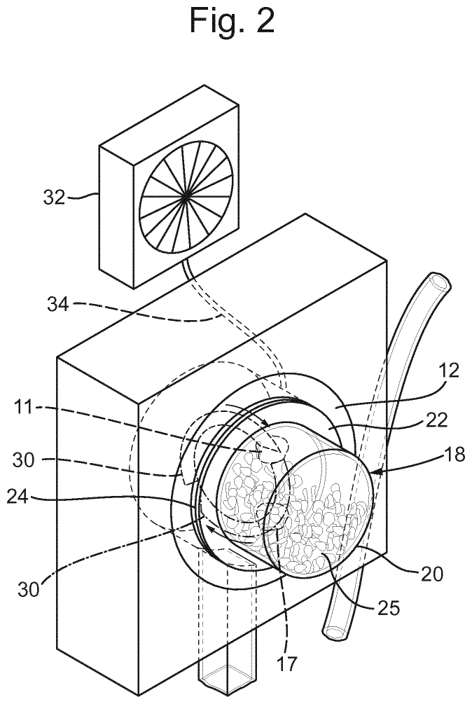

FIG. 2 is a close-up view of a capsule being pierced by as puncturing device.

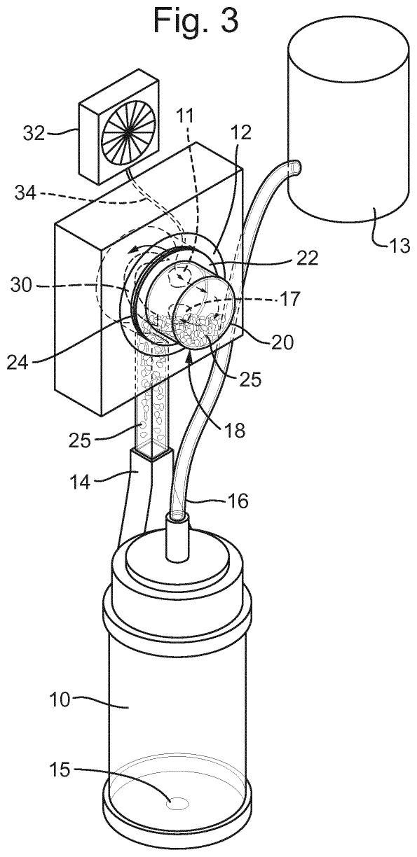

FIG. 3 is a view of the internal group showing the capsule pierced and air blowing the tea particles out of the capsule to the infusion chamber.

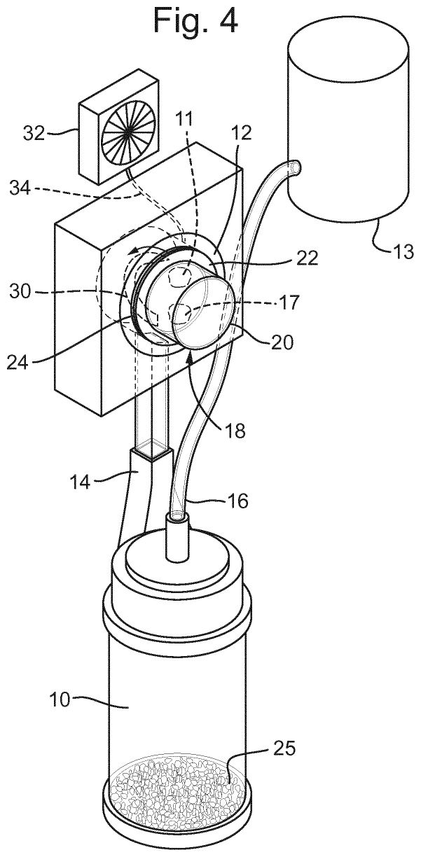

FIG. 4 is a view of the internal group of components after the particulate material has been delivered to the infusion chamber.

Turning to the figures, FIG. 1 shows a group of internal components for use in a beverage machine. The group comprises an infusion chamber 10, a capsule reception location 12, and a channel 14 connecting the capsule reception location 12 with the infusion chamber 10. There is also provided a water reservoir 13 and a water inlet conduit 16 for delivering water from the reservoir to the infusion chamber 10. Although not shown in the figures, the conduit 16 could comprises a water heater, such as an in-line water heater, or the water in the reservoir could be heated. The infusion chamber has a filtered outlet 15, actuatable to deliver a brewed beverage from the infusion chamber 10.

As can be seen, the capsule 18 is remote from the infusion liquid flow path 13, 16, 10.

The apparatus further comprises an arcuate piercer 30 arranged to rotate about a horizontal axis. An air fan 32 is provided together with a conduit 34 for transporting a flowing stream of air from the fan 32 to the capsule reception location 12.

A capsule 18 is also shown before arriving at the capsule reception location 12.

The capsule comprises a transparent plastic body 20 having a rim 22 and covered in a foil lid 24. The capsule contains tea particles 25, loosely contained within the capsule 18.

In use, the capsule is inserted into the beverage machine and it is directed towards the capsule reception location 12.

As best seen in FIGS. 2 and 3, once in place at the capsule reception location 12 the apparatus rotates the arcuate piercer 30 so that it punctures the foil lid 24 of the capsule 18 to form an inlet 11 into the capsule at an upper region of the lid 24. As the arcuate piercer 30 continues to rotate, the piercer 30 travels within the body of the capsule and punctures the foil lid 24 again as it rotates further, forming an outlet 17 from the capsule in a lower region of the foil lid 24 by exiting the lid 24 from the inside of the capsule. Once formed the rotational movement of the piercer is reversed to withdraw the piercer 30 to its starting position.

After the inlet 11 and outlet 17 have been formed the apparatus then engages the air fan 32 which directs a stream of air along conduit 34 into the inlet 11. Air thus flows inside the capsule 18 and is forced out of the capsule via outlet 17. As a result of the flow of air within the capsule, the tea particles become entrained in the stream of air and are dragged out of the capsule 18 along with the air stream out of outlet 17. The air stream and the entrained tea particles then pass down channel 14, as can be seen in FIG. 2.

The tea particles 25 then pass into infusion chamber 10 whereupon the air fan 32 is stopped.

Heated water from a reservoir 13 is then passed through inlet 16 to the infusion chamber, whereupon the tea particles 25 are infused to form a beverage.

Once the beverage has been formed, the filtered outlet 15 in the base of the infusion chamber 10 is opened to allow the beverage to be dispensed for consumption.

The capsule 18 is then ejected to a separate waste compartment, which only contains dry, empty capsules, which can easily be emptied to provide a clean and hygienic disposal of the capsules.

1. An apparatus for preparing a beverage from a capsule containing particulate beverage precursor material, the apparatus comprising:
a capsule reception location configured to receive the capsule;
a beverage infusion chamber having a chamber inlet and a chamber outlet;
a puncturing device configured to puncture the capsule to create a capsule inlet and a capsule outlet;
a channel connecting the capsule reception location to the beverage infusion chamber;
an infusion liquid supply;
an infusion liquid flow path connecting the infusion liquid supply to the chamber inlet of the beverage infusion chamber; and
a device for directing a flowing gas stream into the capsule through the capsule inlet and out of the capsule outlet, so that the particulate beverage precursor material is entrained out of the capsule into the flowing gas stream and the particulate beverage material is subsequently transported along the channel to deliver the particulate beverage precursor material to the beverage infusion chamber.

2. The apparatus of claim 1, wherein the capsule reception location is remote from the infusion liquid flow path.

3. The apparatus of claim 1, wherein the infusion liquid supply is configured to store an amount of liquid, the amount of liquid corresponding to a single portion beverage associated with the capsule; and
wherein the beverage infusion chamber is configured to provide the amount of liquid out of the apparatus via the chamber outlet as a beverage.

4. The apparatus of claim 1, wherein the infusion liquid supply comprises a reservoir for supplying infusion liquid.

5. The apparatus of claim 1, wherein the puncturing device is configured such that, when created, the capsule inlet and the capsule outlet are both located in a lid of the capsule.

6. The apparatus of claim 1, wherein the puncturing device comprises a rotating arcuate piercer configured to form the capsule inlet by entering the capsule from outside the capsule and to form the capsule outlet by exiting the capsule.

7. The apparatus of claim 1, wherein the infusion liquid flow path comprises a heater configured to heat liquid as it travels to the beverage infusion chamber.

8. The apparatus of claim 1, further comprising a separate capsule waste location configured to be isolated from liquid flowing between the beverage infusion chamber, the infusion liquid supply, and the infusion liquid flow path.

9. The apparatus of claim 1, wherein the beverage infusion chamber comprises a filtered outlet through which a beverage is dispensed.

10. The apparatus of claim 1, wherein the beverage infusion chamber is configured to receive a volume of liquid of between 150 ml and 300 ml, inclusive.

11. The apparatus of claim 1, wherein the capsule reception location is configured to receive capsules with an internal volume of between 10 cubic centimeters and 24 cubic centimeters, inclusive.

12. The apparatus of claim 1, wherein the particulate beverage precursor material comprises dried plant material.

13. A method of preparing a beverage from a capsule employing an apparatus having a capsule reception location, a beverage infusion chamber, a channel connecting the capsule reception location and the beverage infusion chamber, a puncturing device, and a device for directing a flowing gas stream into the capsule, the method comprising the steps of:
arranging for a capsule including particulate beverage precursor material to be located at the capsule reception location;
puncturing the capsule to create a capsule inlet and a capsule outlet using the puncturing device;
directing a flowing stream of gas into the capsule through the capsule inlet and out of the capsule outlet using the device, so that the particulate beverage precursor material is entrained out of the capsule into the flowing gas stream and so that the particulate beverage material is subsequently transported along the channel to deliver the particulate beverage precursor material to the beverage infusion chamber;
transporting infusion liquid into the beverage infusion chamber;
carrying out an infusion in the beverage infusion chamber; and
dispensing a beverage from the beverage infusion chamber.
